(19) United States
(12) Patent Application Publication
(10) Pub. No.: US 2003/0230449 A1
(43) Pub. Date: Dec. 18, 2003

(54) Steered wheel angle sensor using hydraulic flow to steering cylinder

(75) Inventors: Frederick W. Nelson, Waukee, IA (US); Lawrence J. Adams, waukee, IA (US); Andrew Karl Wilhelm Rekow, Waterloo, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Deere & Company, Moline, IL

(21) Appl. No.: 10/170,610

(22) Filed: Jun. 12, 2002

(51) Int. Cl. B62D 5/06

(52) U.S. Cl. 180/403; 180/421

(57) ABSTRACT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in/the name of Deere & Company or otherwise.

### BACKGROUND OF THE INVENTION

1. Field of the Invention

The invention relates to a steering system. More particularly the invention relates to a hydraulic steering system adapted to be used to measure the steered wheel angle.

2. Related Art

Hydraulic steering systems provide a known means for steering vehicles. In a typical hydraulic steering system, an operator manually adjusts the position of a steering mechanism, such as a steering wheel. This action causes a steering valve to adjust the flow of hydraulic fluid supplied from a pump to a steering cylinder. This change in the flow of hydraulic fluid results in a change in direction of the steered wheels. Problems arise, however, in developing automatic steering systems. In particular, an automatic steering system needs to determine or measure the steered wheel angle in order to monitor and/or control the steering of the vehicle.

One problem with measuring a steered wheel angle is that the wheels and the steered wheel axis are potentially subject to harsh environmental conditions. This makes locating measurement systems or sensors difficult. Environmental conditions such as dirt or water can adversely impact the accuracy of sensor measurements or damage sensors. Some prior art solutions place sensors in the steering cylinder to measure the position of the steering cylinder. Placing sensors in the steering cylinder also subjects sensors to harsh environmental conditions.

Thus, it is a primary object of the present invention to provide a steering system that improves upon the state of the art.

Another object of the present invention is to provide a steering system that can be used to determine the steered wheel angle of a wheel of a vehicle.

Yet another object of the present invention is to provide a sensing system that can be used to determine a steered wheel angle without directly connecting sensors to the wheels of the vehicle.

A still further object of the present invention is to provide a steering system having a means that can be used to determine wheel angle that need not be located near the steered axle or steered wheels.

These and other objects of the present invention will become apparent from the specification and claims.

### BRIEF SUMMARY OF THE INVENTION

The present invention is a steering system adapted for determining a steered wheel angle of a vehicle. According to the present invention, a vehicle has a spaced apart pair of steered wheels such as may be located along a steered axle. A two-way hydraulic steering cylinder is operatively connected to the steered wheels. A hydraulic circuit is connected to the hydraulic steering cylinder. The hydraulic circuit includes a hydraulic two-way valve and a hydraulic pump for supplying fluid under pressure, to the circuit, the hydraulic pump being hydraulically connected to the valve.

The cylinder has a single moveable shaft to move in opposite directions to steer the wheels in one of two angular directions. The steered wheel angle sensing steering system provides for determining wheel angle by placing a hydraulic motor in the circuit between the cylinder and the valve. An output shaft on the motor is adapted to rotate in one of two directions depending on the direction of flow of fluid through the motor. A pair of sensors adjacent the shaft are used to determine the direction of motion of the shaft and hence an angular steering position of the wheels, the motion of the shaft being related to the steering position of the wheels.

The present invention provides the advantage of a means of determining the wheel angle that may be used as feedback to a control loop of an automatic steering system. Further, the present invention does not require sensors to be directly connected to the steered wheels. In addition, portions of the invention, including the hydraulic motor can be placed well away from the steered axle of the wheels and in a more protected location.

### BRIEF DESCRIPTION OF THE DRAWINGS

FIG. 1 is a schematic showing the steering system according to the present invention.

FIG. 2 is a front view of the steering angle sensor according to the present invention.

FIG. 3 is a top view of the steering angle sensor according to the present invention; and

FIG. 4 is a top view similar to FIG. 3 showing an alternative form of the invention.

### DETAILED DESCRIPTION OF THE INVENTION

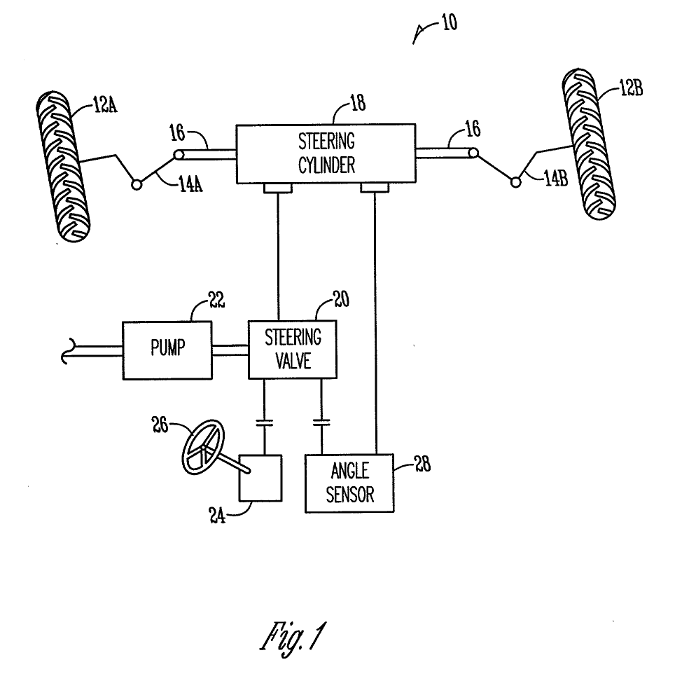

The invention provides for a steering system that includes steered wheel angle sensing in a hydraulic steering system. As shown in FIG. 1, the steering system 10 includes wheels 12A and 12B. Each of these wheels is connected through a linkage 14 (i.e., 14A and 14B) to a two-way hydraulic steering cylinder 18. The two-way hydraulic steering cylinder 18 has a single moveable shaft 16 to move in opposite directions in order to steer the wheels 12 (i.e., 12A and 12B) in one of two angular directions.

The hydraulic steering cylinder 18 forms a portion of a hydraulic circuit. The hydraulic circuit includes a hydraulic two-way steering valve 20 hydraulically connected to the steering cylinder. The two-way hydraulic steering valve 20 is also hydraulically connected to a hydraulic pump 22. The pump 22 provides for supplying fluid under pressure to the hydraulic circuit.

The present invention also provides that the steering valve 20 may be connected through a steering column 24 to a steering mechanism 26 such as a steering wheel. This provides for manually controlled steering in the conventional manner, where manual control is desirable.

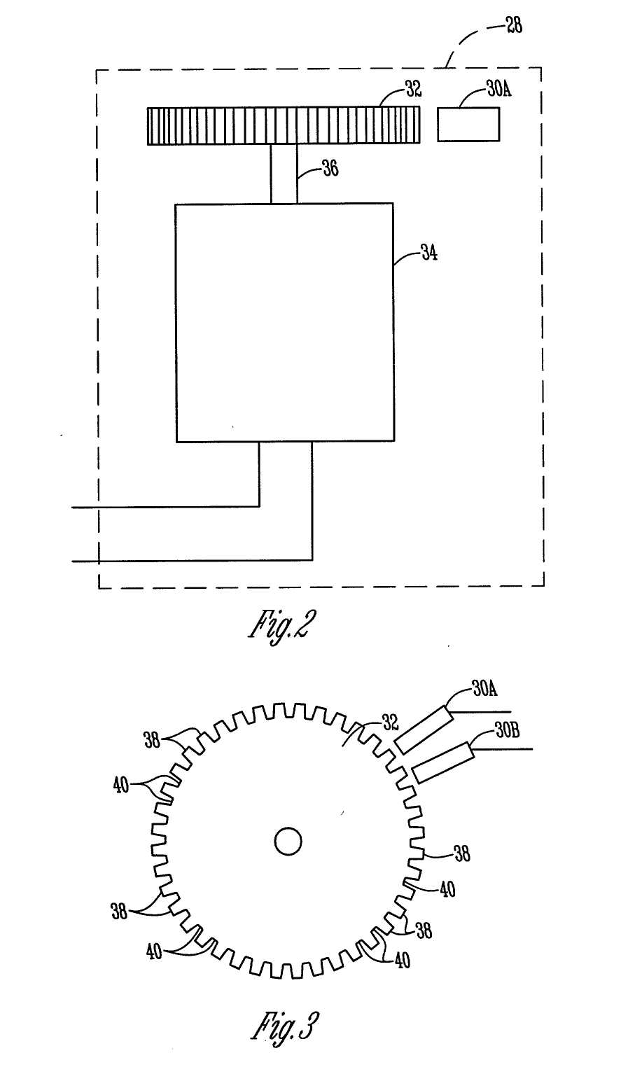

The steering valve 20 is preferably mounted on the bottom of the steering column 24. Also connected to the steering valve 20 is the angle sensor 28. The angle sensor 28 is also hydraulically connected to the steering cylinder 18. The angle sensor 28 is best shown in FIG. 2. The angle sensor is mounted on the vehicle frame, a vehicle axle, in the cab of a vehicle or elsewhere.

In FIG. 2, the angle sensor 28 is shown as having a hydraulic motor 34 in the hydraulic circuit located between a cylinder and the valve. The hydraulic motor 34 has a shaft 36. This output shaft 36 on the motor 34 is adapted to rotate in one of two directions depending on the direction of flow of fluid through the hydraulic motor 34. By measuring the motor shaft motion and direction, the steering angle is inferred.

The relationship between motor shaft motion and steering angle is given by the change in steering angle to the amount of change in motor shaft motion and can vary based on the components used. The change in fluid flow from the steering cylinder corresponds to changes in fluid flow in the hydraulic motor, thus a relationship between shaft motion and steering angle is present. For example, where an operator steers in one direction, there is increased fluid flow to the steering cylinder and therefore a greater steering angle. The fluid flow to the hydraulic motor 34 also increases resulting in an increased speed of rotation of the shaft 36.

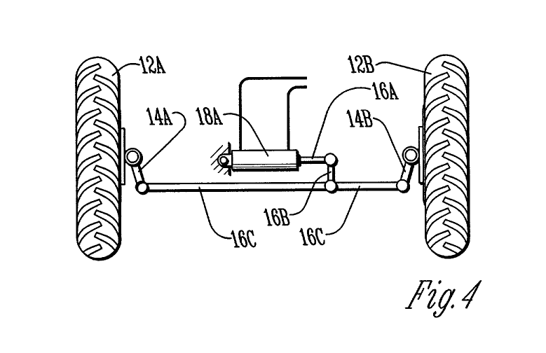

To measure the motor shaft motion and direction, a pair of sensors 30, (i.e., 30A and 30B) adjacent the shaft are used. This is best shown in FIG. 3. In FIG. 3, a toothed wheel 32 is connected to the shaft 36. The sensors 30A and 30B are placed adjacent the toothed wheel. The sensors 30 may be magnetic sensors such as hall effect sensors. The sensors 30 are placed in a quadrature configuration and thus may be used to measure transitions between teeth 38 and gaps 40 of the toothed wheel 32. In this configuration, the sensors 30 are used to measure the amount of rotation, such as by counting the number of teeth 38 that pass by one or both of the sensors in a given period of time. Further, a change of direction of rotation is also detectable as this configuration allows the transitions between the teeth 38 and unteethed portions 40 of the wheel to be detected and evaluated.

Although preferably a toothed wheel 32 is used, the present invention contemplates that measurements can be taken of the shaft 36 itself instead of the toothed wheel 32 connected to the shaft 36. Where a toothed wheel 32 is used, one convenient size of toothed wheel is a five inch diameter wheel, but the present invention contemplates any size. The present invention also contemplates that other types and placements of sensors may be used.

This configuration provides a number of advantages. By measuring the direction of rotation and amount of rotation of cylinder corresponds to changes in fluid flow in the hydraulic motor, thus a relationship between shaft motion and steering angle is present. For example, where an operator steers in one direction, there is increased fluid flow to the steering cylinder and therefore a greater steering angle. The fluid flow to the hydraulic motor 34 also increases resulting in an increased speed of rotation of the shaft 36.

This configuration provides a number of advantages. By measuring the direction of rotation and amount of rotation of the motor shaft, the steered angle can be determined thus that this information can be used within an automatic steering system. In an automatic steering system, the steered wheel angle can be used as feedback in a control loop. Another advantage of this configuration is that the steer angle sensor 28 may be placed well away from the steering cylinder 18, steered axle or wheels 12. Preferably, the steered wheel angle sensor 28 is placed in a more environmentally secure position, instead of near the steered wheels 12 or steered axis. For example, where the steering system of the present invention is used in farm equipment, the steering angle sensor 28 can be placed in a cab of the vehicle or otherwise positioned in order to be better protected from environmental conditions that could affect the sensors.

Further, the sensors 30 need not be directly connected to the shaft 36. As shown, the present invention contemplates that the hall effect sensors 30 or other noncontact sensors can be used to measure the direction and amount of rotation of the motor shaft.

An alternative form of the invention is shown in FIG. 4. A two-way cylinder 18A is pivotally secured by one end to the vehicle frame 16B. Cylinder 18A is connected by suitable hydraulic hoses to the same components that cylinder 18 is connected as shown in FIG. 1. A reciprocal piston rod 16A extends from the other end of cylinder 18A. The outer end of rod 16A is pivotally secured by linkage 16B to elongated tie rod 16C. Rod 16C is pivotally connected to wheels 12A and 12B by linkage 14A and 14B. When the reciprocal rod 16A moves, tie rod 16C moves correspondingly to steer the wheels 12A and 12B in one direction or the other via links 14A and 14B, respectively. This arrangement has all the functional advantages of the cylinder elated hydraulic components of FIG. 1.

Thus, a steered wheel angle sensing steering system has been disclosed which solves problems and deficiencies in the art.

What is claimed is:

1. A steered wheel angle sensing steering system for vehicles having one or more steered wheels, one or more two-way hydraulic steering cylinders operatively connected to the steered wheels, and a hydraulic circuit connected to the cylinder, comprising:
a hydraulic two-way valve;
a hydraulic pump for supplying fluid under pressure to the circuit and being hydraulically connected to the valve;
the cylinder having a single moveable shaft therein to move in opposite directions to steer the wheels in one of two angular directions;
a hydraulic motor in the circuit between the cylinder and the valve;
a power shaft associated with the motor adapted to rotate in one of two directions depending on the direction of flow of fluid through the motor; and
a pair of sensors adjacent the shaft to determine the direction of motion of the shaft, and hence an angular steering position of the wheels.

2. The steering system of claim 1 further comprising a toothed wheel connected to the output shaft.

3. The steering system of claim 2 wherein the pair of sensors are positioned in a quadrature configuration.

4. The steering system of claim 1 wherein the sensors are magnetic sensors.

5. The steering system of claim 4 wherein the magnetic sensors are hall effect sensors.

6. The steering system of claim 1 further comprising a steering mechanism operatively connected to the valve.

7. The steering system of claim 6 wherein the hydraulic motor is positioned such that the hydraulic motor is more proximate to the steering valve than to the steering cylinder.

8. A steering system for vehicles having a two-way hydraulic steering cylinder operatively connected to a hydraulic circuit, comprising:
a two-way hydraulic steering valve hydraulically connected to the steering cylinder;
a hydraulic pump for supplying fluid under pressure to the circuit and being hydraulically connected to the valve;
the cylinder having a single moveable shaft therein to move in opposite directions;
a hydraulic motor hydraulically connected between the cylinder and the valve;
a power shaft associate with the motor adapted to rotate in one of two directions depending on the direction of flow of fluid through the motor;
a toothed wheel mounted on the output shaft and rotating with the shaft; and
a first sensor and a second sensor positioned adjacent the toothed wheel for determining an amount of rotation of the toothed wheel and a direction of rotation of the toothed wheel.

9. The steering system of claim 8 wherein the first and the second sensors are magnetic sensors.

10. The steering system of claim 9 wherein the magnetic sensors are hall effect sensors.

11. The steering system of claim 8 further comprising a spaced pair of steered wheels operatively connected to the steering cylinder.

12. The steering system of claim 8 further comprising a steering mechanism operatively connected to the steering valve.

13. The steering system of claim 12 wherein the steering mechanism is a steering wheel.

14. The steering system of claim 8 wherein the first sensor and the second sensor are positioned adjacent the toothed wheel in a quadrature configuration.

15. The steering system of claim 8 wherein the hydraulic motor is positioned such that the hydraulic motor is more proximate to the steering valve than to the steering cylinder.

16. The steering system of claim 1 wherein the movable shaft is connected to an elongated tie rod which is pivotally linked to the wheels.

17. The steering system of claim 8 wherein the movable shaft is connected to an elongated tie rod which is pivotally linked to the wheels.

18. The steering system of claim 1 wherein the movable shaft slidably extends out of opposite ends of the cylinder to be pivotally limited to the wheels.

19. The steering wheel of claim 8 wherein the movable shaft slidably extends out of opposite ends of the cylinder to be pivotally limited to the wheels.

20. A steered wheel angle sensing steering system for vehicles having at least one steered wheel, and a two way hydraulic steering cylinder operatively connected to the steered wheel, and a hydraulic power fluid circuit connected to the cylinder to cause the cylinder to be selectively operated in first and second directions to steer the wheel in first and second directions, comprising,
a sensor in the power fluid circuit to meter the flow of fluid to and from the cylinder to determine the angular steering position of the wheel.

21. The steering system of claim 20 wherein a two-way valve is located in the circuit.
